(19) United States
(12) Patent Application Publication
(10) Pub. No.: US 2023/0399531 A1
(43) Pub. Date: Dec. 14, 2023

(54) SURFACE MATERIAL

(71) Applicant: JAPAN VILENE COMPANY, LTD., Tokyo (JP)

(72) Inventors: Yoshinori OTAKI, Moriyama-shi (JP); Kan MATSUSHIMA, Moriyama-shi (JP); Masashi YAGI, Moriyama-shi (JP)

(21) Appl. No.: 18/331,707

(22) Filed: Jun. 8, 2023

(30) Foreign Application Priority Data
Jun. 9, 2022 (JP) 2022-94005
Jun. 1, 2023 (JP) 2023-90809

(51) Int. Cl. C09D 11/03; C09D 11/023; C09D 7/20; C09D 7/43; C09D 7/63; C09D 5/02

(52) U.S. Cl. CPC C09D 11/03; C09D 11/023; C09D 7/20; C09D 7/43; C09D 7/63; C09D 5/024

(57) ABSTRACT

The surface material according to the present disclosure is a surface material partially comprising prints on at least one main surface of a black fabric, in which brightness difference (ΔL, ΔL=Lp−Lb) between average brightness on the main surface of the black fabric (Lb) and average brightness on the print which exists on the main surface (Lp) is smaller than 0. In other words, in the surface material according to the present disclosure, the print is more darkly represented than a black fabric. In view of the above, according to the present disclosure, it is possible to provide a surface material capable of realizing an automotive interior material having a calm impression and improved design properties by representing a print on a main surface of a black fabric darker (specifically, blacker) than the black fabric.

### TECHNICAL FIELD

The disclosure relates to a surface material.

### BACKGROUND ART

Conventionally, as a surface material of an automotive interior material such as a ceiling material for example as disclosed in JP2012-179985A (Patent Literature 1), a decorative fiber sheet having a print containing a pigment on a surface of a fabric is used.

In addition, by using a surface material including a dark-colored fabric such as black, brown or dark blue, it is possible to realize an automotive interior material that gives a calm impression. Therefore, there is a need for a surface material using a dark fabric, particularly a black fabric, which provides a calmer impression.

Further, in order to improve the design properties, a surface material partially provided with a print on a main surface of the dark-colored fabric (particularly, a black fabric) has been studied. In the surface material, the pattern is expressed by a partially existing print.

From this viewpoint, the applicant of the present application has provided a surface material disclosed in, for example, JP-A-2020-002496 (Patent Literature 2). Patent literature 2 discloses as an Example, a surface material partially provided with a print containing a black pigment on at least one main surface of a black fabric.

### CITATION LIST

### Patent Literature

[Patent Literature 1] JP2012-179985A
[Patent Literature 2] JP2020-002496A

### SUMMARY

### Technical Problem

However, the surface material provided had the following problems.

In order to realize an automotive interior material with improved design properties, in the case of a surface material which is partially provided with a print on a main surface of a black fabric, the print needs to be expressed darker (blacker) than the black fabric. In other words, the brightness difference (ΔL, ΔL=Lp−Lb) between the average brightness on the main surface of the black fabric (Lb) and the average brightness on the print which exists on the main surface of the black fabric (Lp) needs to be less than 0. The smaller the value of the average brightness, the darker the black color. The smaller the brightness difference (ΔL) is compared to 0, the darker (blacker) the print is expressed compared to the black fabric.

However, in the surface material produced, it was strange that the print containing the black pigment present on the main surface of the black fabric looked lighter in color than the black fabric. Actually, when the brightness difference (ΔL) was measured, the value was not less than 0. And this problem was most occurred when using darker black fabrics.

Therefore, the applicant attempted to increase the amount of the black pigment contained in the printing liquid. However, even when the amount of the black pigment contained in the printing liquid was increased, the average brightness (Lp) of the print did not change greatly. Therefore, it was not possible to provide a surface material having a brightness difference (ΔL) value less than 0.

Further, when the amount of the pigment contained in the print is increased, a new problem occurred in that the pigment was easily fallen off with the print from the surface material. This means that when the surface material and a cloth such as clothing rub with each other, the pigment is easily transferred from the surface material to the cloth. Therefore, such a surface material deteriorates design properties as the print falls off, and thus has poor practicality.

From the above, as far as the prior art is concerned, it is not possible to provide a surface material capable of realizing an automotive interior material having a calm impression and improved design properties. In addition, it is not possible to provide a surface material capable of realizing an automotive interior material that has high practicality and is difficult to cause color migration.

### Solution to Problem

The present disclosure provides:

(Claim 1) A surface material, including: a print provided on a part of a main surface of a black fabric, in which a brightness difference (ΔL, ΔL=Lp−Lb) between an average brightness on the main surface of the black fabric (Lb) and an average brightness on the print provided on the main surface (Lp) is less than 0.

(Claim 2) The surface material according to claim 1, in which the print contains a fluorine-based water and oil repellent.

(Claim 3) The surface material according to claim 2, in which the fluorine-based water and oil repellent has a crosslinked moiety having a chemical structural formula of —NH—C(═O)—.

(Claim 4) The surface material according to claim 1, in which the print contains a silicone-based water repellent having a crosslinked moiety having a chemical structural formula of —NH—C(═O)—.

(Claim 5) The surface material according to claim 1, in which the surface material has been evaluated as 4-5th grade or 5th grade as a result of a judgment for staining on a surface of a white cotton cloth rubbed against the main surface of the surface material after being subjected to “a) dry test” in “9.2 Rubbing Tester II Method” in “Test methods for color fastness to rubbing (JIS L0849: 2013)”. The judgement is carried out in accordance with “Table 3—Judgment criteria for staining” in “3) Judgment of Staining” in “General principles of testing methods for color fastness (JIS L0801: 2011)”.

### Advantageous Effects of the Disclosure

The surface material according to the present disclosure is a surface material partially comprising prints on at least one main surface of a black fabric, wherein brightness difference (ΔL, ΔL=Lp−Lb) between average brightness on the main surface of the black fabric (Lb) and average brightness on the print which exists on the main surface (Lp) is smaller than 0.” In other words, in the surface material according to the present disclosure, the print is more darkly represented than a black fabric. The applicant of this present application has found that when the print contains a fluorine-based water and oil repellent, the surface material according to the present disclosure can be provided.

In addition, the applicant of the present application has found that when the fluorine-based water and oil repellent included in the print has a crosslinked moiety having a chemical structural formula of —NH—C(═O)—, it is difficult for the print to fall off from the surface material. Therefore, it has been found that it is possible to provide a surface material that is unlikely to cause deterioration in design properties due to a fall off of a print.

In addition, the applicant of the present application has found that when the print comprises a silicone-based water repellent having a crosslinked moiety with a chemical structural formula of —NH—C(═O)—, it is possible to provide a surface material according to the present disclosure, and it is difficult for the print to fall off from the surface material. Therefore, it has been found that it is possible to provide a surface material that is unlikely to cause deterioration in design properties due to a fall off of a print.

Further, with respect to the surface material according to the present disclosure, when the result determined by the measurement method according to the present disclosure is the staining class 4-5th grade or the staining class 5th grade, it has the effect of realizing an automotive interior material which is difficult to cause color migration and is rich in practicality.

In view of the above, according to the present disclosure, it is possible to provide a surface material capable of realizing an automotive interior material having a calm impression and improved design properties by representing a print on a main surface of a black fabric darker in color (specifically, blacker) than the black fabric.

Further, according to the present disclosure, it is possible to provide a surface material that can realize an automotive interior material that is difficult to cause color migration and has high practicality.

### DESCRIPTION OF EMBODIMENTS

In the present invention, various configurations such as, for example, the following configurations can be appropriately selected.

Note that various measurements described in the present disclosure were measured under temperature conditions of 25° C. and under atmospheric pressure unless otherwise specified.

Then, unless otherwise stated, various measurement results explained in the present disclosure were obtained by measuring a value that is one order of magnitude smaller than the desired value, and rounding the obtained value to the nearest number to calculate the desired value. As a specific example, in the case where the desired value is a number to the first decimal place, a value to the 2nd decimal place is obtained by measurement, then the 1st decimal place is calculated by rounding the numerical value of the 2nd decimal place, and the thus obtained value is used as the desired value.

In addition, the upper limit values and the lower limit values exemplified in the present disclosure can be appropriately combined.

A surface material according to the present disclosure is partially provided with a print on at least one main surface of a black fabric. In the present disclosure, the “main surface” refers to a surface having the largest area.

The black fabric capable of constituting the surface material of the present disclosure refers to a fabric that contains a fiber kneaded with black pigment (so-called dyed fiber). Alternatively, the black fabric capable of constituting the surface material of the present disclosure refers to a fabric dyed with a black dye, a fabric of which at least one of the main surfaces is entirely coated with a black pigment, and the like. In particular, it Is preferably the fabric in which the dyed fibers are employed as constituent fibers (preferably, a fabric in which only the dyed fibers are employed as constituent fibers). By using such a fabric, it is easy to provide a surface material in which the pigment hardly falls off with the print from the surface material. As a result, it is possible to provide a surface material which is difficult to cause color migration and is capable of realizing an automotive interior material having high practicality.

Further, the type of the fabric can be appropriately selected, for example, a nonwoven fabric, a woven fabric or a knitted fabric. In particular, when the black fabric is a nonwoven fabric, it is preferable because it can provide a surface material that is flexible and has a soft texture and improved design.

The constituent fibers of the black fabric can be formed using a known organic resin. For example, a polyolefin-based resin (e.g., polyethylene, polypropylene, polymethylpentene, a polyolefin-based resin having a structure in which a part of a hydrocarbon is replaced with a halogen such as a cyano group or fluorine or chlorine), a styrene-based resin, a polyvinyl alcohol resin, a polyether-based resin (e.g., polyether ether ketone, a polyacetal, a modified polyphenylene ether, an aromatic polyether ketone, or the like), a polyester-based resin (e.g., polyethylene terephthalate, a polytrimethylene terephthalate, polybutylene terephthalate, polyethylene naphthalate, polybutylene naphthalate, polycarbonate, polyarylate, wholly aromatic polyester resins), a polyimide resin, polyamide-imide resins, polyamide-based resins (e.g., aromatic polyamide resins, aromatic polyether amide resins, nylon resins, etc.), resins having a nitrile group (e.g., polyacrylonitrile and the like), urethane-based resins, epoxy-based resins, polysulfone-based resins (e.g., polysulfone, polyether sulfone, and the like), fluorine-based resins (e.g., polytetrafluoroethylene, polyvinylidene fluoride, and the like), cellulose-based resins, polybenzimidazole resins, acrylic resins (e.g., polyacrylonitrile-based resins obtained by copolymerizing acrylic esters or methacrylic esters, etc., modaacrylic resins obtained by copolymerizing acrylonitrile with vinyl chloride or vinylidene chloride, and the like), and the like can be used.

Note that these resins may be made of any of a linear polymer or a branched polymer. The organic resin may be a block copolymer or a random copolymer. In addition, the presence or absence of the three-dimensional structure or crystallinity of the organic resin is not particularly limited. Further, a mixture of multi-component organic resins may be used.

When flame retardancy is required for the surface material, it is preferable that the constituent fibers of the black fabric contain a flame retardant organic resin. Examples of such a flame retardant resin include, for example, modaacrylic resin, vinylidene resin, polyvinyl chloride resin, polyvinylidene fluoride resin, novoloid resin, polychlal resin, polyester resin obtained by copolymerizing a phosphorus compound, halogen-containing monomer copolymerized acrylic resin, aramid resin, and a resin kneaded with a flame retardant halogen-based or phosphorus-based or metal compound-based.

The constituent fibers of black fabrics can be obtained by known methods, for example, melt spinning, dry spinning, wet spinning, direct spinning (melt blowing, span bonding, electrostatic spinning, etc.), extraction of fibres with thin fiber diameters by removing one or more resin components from composite fibers, and decomposition of fibres to obtain split fibers.

The constituent fibers may be made of a single type of organic resin. Alternatively, the constituent fibers may be made of a plurality of types of organic resins. The fibers composed of a plurality of types of organic resins may be fibers generally referred to as composite fibers, for example, fibers in the form of a sheath-core type, an island-sea type, a side-by-side type, an orange type, a bimetallic type, or the like.

Further, the constituent fibers may contain a deformed cross sectional fiber other than a substantially circular fiber or an oval fiber. Incidentally, the deformed cross sectional fiber may be a fiber having a cross sectional shape in a hollow shape, polygonal shape such as a triangular shape, alphabet character-type shape such as a Y-shape, irregular shape, multileaf shape, symbol-type shape such as an asterisk shape or a fiber having a cross sectional shape of a combination of a plurality of these shapes.

The constituent fibers may include heat-fusible fibers. In this case, strength and morphological stability can be imparted to the black fabric by thermally fusing the fibers together. Therefore, it is further preferable because the surface material having improved design properties by reducing fluffing and scattering of fibers can be obtained. Such heat-fusible fibers may be all-fusible heat-fusible fibers. Alternatively, it may be partially-fusible heat-fusible fibers such as the above-described composite fiber.

The type of the component exhibiting the heat-fusible property of the heat-fusible fibers can be appropriately selected. For example, a low-melting-point polyolefin resin, a low-melting-point polyester resin, or the like can be used.

When the black fabric includes crimpable fibers, it is possible to provide a surface material having increased stretchability, excellent followability to the mold, and improved design properties. As such crimped fibers, for example, crimped fibers having a crimp of latent-crimped-fibers, fibers having a crimp, and the like can be used.

The fineness of the constituent fibers of the black fabric is not particularly limited. It can be 1 dtex or more, can be 1.5 dtex or more, and can be 2 dtex or more so as to be a surface material with improved design properties. On the other hand, it can be 100 dtex or less, can be 50 dtex or less, 30 dtex or less, and can be 10 dtex or less so as to be a surface material with improved design properties due to uniform texture.

The average fiber length of the constituent fibers of the black fabric is not particularly limited. It can be 20 mm or more, can be 25 mm or more and can be 30 mm or more, so that it is a surface material with improved design properties due to uniform texture. On the other hand, when the average fiber length exceeds 110 mm, a fiber mass tends to be formed during the preparation of the black fabric. As a result, the formation is not uniform, and there is a possibility that a surface material with improved design properties cannot be provided. Therefore, the average fiber length can be 110 mm or less, or 60 mm or less. Note that, the “average fiber length” refers to a value measured according to 8.4.1c) direct method (method C) in JIS L1015 (2010).

In the above-described black fabric, a part or all of the adhesive fibers may be melted by heat treatment such that the constituent fibers are integrated by melt bonding.

The method of the heat treatment at that time can be appropriately selected. For example, a method of heating or pressurizing with heat by a roll, a method of heating by a heater such as an oven dryer, a far-infrared heater, a dry heat dryer or a hot air dryer, or a method of heating by irradiating infrared rays under no pressure to heat an organic resin contained therein, or the like can be used.

The type of binder resin that can be used to the black fabric is appropriately selected. For example, polyolefin based resin (modified polyolefin etc.), ethylene vinyl alcohol copolymer, ethylene-acrylate copolymers such as ethylene-ethylacrylate copolymer, various rubbers and their derivatives (styrene-butadiene rubber (SBR), fluorine rubber, urethane rubber, ethylene-propylene-diene rubber (EPDM), etc.), cellulose derivatives (carboxymethyl cellulose (CMC), hydroxyethyl cellulose, hydroxypropyl cellulose, etc.), polyvinyl alcohol (PVA), polyvinyl butyral (PVB), polyvinylpyrrolidone (PVP), polyurethane, epoxy resin, polyvinylidene fluoride (PVdF), vinylidene fluoride-hexafluoropropylene copolymer (PVdF-HFP), acrylic resin, and the like can be used. In particular, when the binder resin contains an acrylic resin, since it is appropriately softened at the time of heat molding such as heat pressing using a mold, it is preferable because a surface material with excellent conformability to molds and improved design can be obtained.

The amount of the binder resin contained in the black fabric is appropriately selected. The larger the amount of the binder resin is, the smoother the main surface, so that it is possible to provide the surface material with improved design properties, which is preferable. Therefore, the amount of the binder resin contained in the black fabric is preferably 2 g/m² or more. On the other hand, when the amount of the binder resin is excessively large, due to the poor flexibility of the black fabric, there is a risk that the conformability to molds may be poor when the surface material is molded. Therefore, the binder resin amount is preferably 20 g/m² or less, and preferably 10 g/m² or less.

In addition, the binder resin may contain additives such as a flame retardant, a fragrance, a pigment (an inorganic pigment and/or an organic pigment), an antibacterial agent, an antifungal agent, photocatalyst particles, an emulsifier, a dispersant, a thickener or an antifoaming agent, in addition to the above-described resins.

Various configurations of the black fabric, such as thickness and basis weight, are not particularly limited and are appropriately selected. For example, the thickness of the black fabric can be 0.5 to 5 mm, 1 to 3 mm or 1.1 to 1.9 mm. Also, the basis weight of the black fabric can be 50 to 500 g/m², 80 to 300 g/m² or 100 to 250 g/m².

In the present disclosure, the thickness refers to the length of the measurement target in the vertical direction when a compressive load of 20 g/cm² is applied in a direction perpendicular to the main surface of the measurement target. Further, the basis weight refers to a mass obtained by converting the mass of the measurement target to that per 1 m² on the main surface of the measurement target.

The surface material of the present disclosure partially comprises prints on at least one main surface of a black fabric. In particular, at least a part of the prints (including prints that are darker [specifically, blacker] than the black fabric) is exposed on the main surface of the surface material. By being a surface material having such the prints, it is possible to provide a surface material capable of realizing an automotive interior material having a calm impression and improved design properties.

As long as the surface material according to the present disclosure can be realized, the composition of the print can be adjusted. Further, it may be the prints containing a black pigment. However, in the prior art just by using black pigments, it is not possible to realize a surface material in which the prints are darker (more specifically, blacker) than the black fabric and the prints containing pigments are prevented from falling off from the surface material.

The applicant of the present application has found that, when the print contains: a fluorine-based water and oil repellent and/or a silicone-based water repellent having a crosslinked moiety with a chemical structural formula of —NH—C(═O)— (hereinafter, sometimes referred to as a crosslinked silicone-based water repellent), it is possible to provide a surface material in which the print is more darkly represented than a black fabric, as is clear from the measurement results of the brightness difference (ΔL) described later.

The reason for this is not completely clear, but it is considered that the following effects have been demonstrated.

By including the fluorine-based water and oil repellent and/or a crosslinked silicone-based water repellent, the refractive index of light in the print is changed. As a result, it is considered that the underlying color (the color of the black fabric) visible through the print looks darker. Therefore, even if the print does not contain a black pigment, it is possible to realize a surface material in which the print is darker than the black fabric (specifically, blacker).

The fluorine-based water and oil repellent referred to herein is an organic compound having a molecular chain that contains a fluorine atom and is shorter than a polymer, an organic compound having a molecular chain that contains a fluorine atom and is an oligomer or shorter than an oligomer or a low-molecular organic compound containing a fluorine atom (for example, a fluorine-based water and oil repellent having 6 carbon atoms). Therefore, the fluorine-based water and oil repellent is not a concept including a fluorine-based polymer such as a fluororubber. As such a fluorine-based water and oil repellent, Asahi Guard AG-E300D (product name, registered trademark), AG-E082E, and AG-550D manufactured by Asahi Glass Co., Ltd., and the like can be adopted.

Here, the silicone-based water repellent is a low-molecular organic compound containing a silicon atom. As such a silicone-based water-repellent, neo-seed NR-8800 (product name, registered trademark), NR-7080, and NR-8000 manufactured by Nikka Chemical Co., Ltd., and the like can be adopted. And it can be a silicone-based water repellent having a crosslinked moiety with a chemical structural formula of —NH—C(═O)— derived from these silicone-based water-repellents.

The mass of the fluorine-based water and oil repellent and/or the crosslinked silicone-based water repellent contained in the print can be appropriately adjusted. The percentage of the mass of the fluorine-based water and oil repellent and/or the crosslinked silicone-based water repellent in the mass of the print can be 1 to 99% by mass, 5 to 95% by mass or 40 to 93% by mass.

Note that, it is preferable that the print does not contain a black pigment in order to realize a surface material from which the print hardly falls off.

In addition, it is preferable that the fluorine-based water and oil repellent and/or a crosslinked silicone-based water repellent are included only in the print so as to be able to realize a surface material in which the print is darker than a black fabric (specifically, blacker).

In addition to the print containing the fluorine-based water and oil repellent and/or a crosslinked silicone-based water repellent, other prints with different compositions may also be included. For example, it may be a surface material having another print containing a white pigment in addition to the print containing the fluorine-based water and oil repellent and/or a crosslinked silicone-based water repellent. Accordingly, it is preferable because a surface material capable of realizing an automotive interior material having more improved design properties having an intricate pattern can be provided.

Furthermore, the applicant of the present application have found that when the fluorine-based water and oil repellent or the silicone-based water repellent contained in prints is crosslinked by an isocyanate-based compound such as a blocked isocyanate-based compound (where the isocyanate group is protected by a blocking agent) and has a crosslinked moiety with the chemical structural formula of —NH—C(═O)—, the print is difficult to fall off from the surface material.” Therefore, it has been found that it is possible to provide a surface material that hardly causes deterioration of design properties due to a fall off of the print.

The reason for this is not completely clear, but it is considered that the following effects have been demonstrated. It is considered that the isocyanate-based compound acts as a crosslinking agent for the fluorine-based water and oil repellent and/or the silicone-based water repellent, thereby improving the strength of the print. At this time, the fluorine-based water and oil repellent and the silicone-based water repellent included in the print are crosslinked by an isocyanate-based compound and have a crosslinked moiety having a chemical structural formula of —NH—C(═O)—. And, between the fluorine-based water and oil repellents and/or between the fluorine-based water and oil repellent and the constituent fibers of the black fabric, or, between the isocyanate-based compounds and/or between the isocyanate-based compound and the constituent fibers of the black fabric, crosslinking is formed by a chemical structure having an —NH—C(═O)—.

Whether the fluorine-based water and oil repellent or the silicone-based water-repellent has the crosslinked part can be determined by subjecting the sample collected from the print to various analyzers such as NMR and FT-IR and analyzing the sample. For example, NY-99 (product name) manufactured by Nikka Chemical Co., Ltd., can be adopted as the isocyanate-based compound, and SU-268A (product name), Maicanate TP-10 (product name) or maicanate CX (product name) manufactured by Meisei Chemical Industry Co., Ltd., can be adopted as the blocked isocyanate-based compound.

The mass of the isocyanate-based compound added to the print can be adjusted as appropriate. The percentage of the isocyanate-based compound in the mass of the print may be 3 to 30% by mass.

The print may contain a resin in addition to the fluorine-based water and oil repellent and/or the silicone-based water repellent and the isocyanate-based compound. As the resin, the above-described resins exemplified as being employable as binder resins (for example, an acrylic resin, etc.) can be employed. However, it is preferable that the print does not contain a thermoplastic resin to realize a surface material on which surface a thermoplastic resin layer is not exposed and present.

The print may be provided partially, i.e. on a part of at least one main surface of the black fabric. The presence mode of the print can be selected as appropriate. For example, the print may be provided on a part of the main surface so as to form a pattern such as a line shape, a dot shape or an irregular shape. The print may be one type or a plurality of types. Note that, as long as the print is partially provided on at least one main surface of the surface material, the print may be present on the other main surface of the surface material. The print may also be in the form of penetrating into the internal of the black fabric.

The mass of the print present on one main surface of the black fabric is selected as appropriate. If the mass is too large, the moldability of the surface material may deteriorate during the molding process. Therefore, the mass of the print is preferably 50 g/m² or less, and 30 g/m² or less. The lower limit can be appropriately selected, but can be 1 g/m² or more, can be 5 g/m² or more, and can be 10 g/m² or more.

The surface material of the present disclosure has ΔL smaller than which is measured by the following method of measuring brightness difference.

### (Method of Measuring Brightness Difference)

1. A surface material partially comprising prints on at least one main surface of a black fabric is provided.
2. An integrating sphere spectrophotometer (X-Rite Co., Ltd., Color i5, light source: D65 light source, measuring method: SCI method) conforming to the spectrophotometric method of JIS Z8722 (2009) is prepared. The color difference measured by the present integrating sphere spectrophotometer is a color difference represented by CIE1976L*a*b* color system.
3. Using an integrating sphere spectrophotometer, the brightness of the portion of the main surface on which the black fabric is exposed is measured at three portions. The average value is defined as the average brightness (Lb) on the main surface of the black fabric. The lower the average brightness, it means the black fabric is blacker.
4. Similarly, the brightness is measured at three portions where the print exists on the one main surface side. Then, the average is defined as the average brightness (Lp) of the print. Note that, the lower the average brightness is, a print looks blacker.
5. The Value of Lp minus Lb is defined as the brightness difference (ΔL) of the surface material partially comprising prints on at least one main surface of a black fabric.

When the value of the brightness difference (ΔL) calculated as described above is less than 0, it means that the print is darker (specifically, blacker) than the black fabric. As a result, it is a surface material that gives a calm impression and has a pattern on which the print is darker (specifically, blacker) than the black fabric. Therefore, it is a surface material capable of realizing an automotive interior material having improved design properties.

On the other hand, a surface material having a brightness difference (ΔL) value of 0 or more is a surface material in which the print looks the same as or lighter in color than the black fabric. Therefore, it is a surface material that cannot realize an automotive interior material having a calm impression and improved design properties.

The smaller the value of the brightness difference (ΔL) is than 0, it is possible to provide a surface material capable of realizing an automotive interior material having a calmer impression and improved design properties. Therefore, the brightness difference (ΔL) is preferably −0.5 or less, preferably −0.9 or less, preferably −1.5 or less, preferably −2.0 or less and preferably −2.3 or less.

In addition, the surface material according to the present disclosure is highly resistant against friction. Specifically, the staining class can be 4-5th grade or 5th grade evaluated by the following measurement method.

### (Method for Resistant Against Friction)

1. A surface material partially comprising prints on at least one main surface of a black fabric is provided.
2. The main surface partially provided with a print of the surface material, is subjected to the “a) dry test” in “9.2 Rubbing Tester II Method” in “Test methods for color fastness to rubbing (JIS L0849: 2013)”. In this test, a white cotton cloth prepared for the test is rubbed against said main surface.
3. Confirm the surface of the white cotton cloth used in the test (the white cotton cloth after rubbed with said main surface). As a result of the confirmation, the degree of color transfer of the print containing the pigment from the black fabric to the white cotton cloth is determined by performing the test. Specifically, the determination is made using “Table 3—Judgment criteria for staining” in “3) Judgment of Staining” in “General principles of testing methods for color fastness (JIS L0801: 2011)”. The criteria are cited as Table 1 below.

TABLE 1
Judgment Criteria for Staining

| Staining | |
|---|---|
| Class | |
| (grade) | Judgment Criteria |
| 5 | Staining is about the order of 5 in the gray scale for staining. |
| 4-5 | Staining is about the order of 4-5 in the gray scale for |
| | staining. |
| 4 | Staining is about the order of 4 in the gray scale for staining. |
| 3-4 | Staining is about the order of 3-4 in the gray scale for |
| | staining. |
| 3 | Staining is about the order of 3 in the gray scale for staining. |
| 2-3 | Staining is about the order of 2-3 in the gray scale for |
| | staining. |
| 2 | Staining is about the order of 2 in the gray scale for staining. |
| 1-2 | Staining is about the order of 1-2 in the gray scale for |
| | staining. |
| 1 | Staining is about the order of 1 or more in the gray scale for |
| | staining. |

As a result of subjecting the black fabric with the print to the evaluation method described above, the surface material having the staining class 4-grade or more preferably the staining class 5th grade is a surface material having a high resistance against friction. Therefore, it is a surface material capable of realizing an automobile interior material that has high practicality and is difficult to cause color migration.

On the other hand, the surface material whose determination result is the evaluation of the staining class 4th grade or a lower grade is a surface material which is inferior in the resistance against friction. Therefore, it is a surface material that is easy to cause color migration and cannot realize an automobile interior material having high practicality.

When a black fabric having a print which does not contain a black pigment is subjected to the above-described evaluation method, no color migration of the print containing the pigment can occur on the white cotton cloth after being subjected to measurement. Therefore, the measurement result in this case is also staining class 5th grade.

The thickness of the surface material is appropriately selected. For example, it can be 2.5 mm or less, 2 mm or less and 1.5 mm or less. On the other hand, the lower limit of the thickness is appropriately adjusted. For example, it is practical to be 0.5 mm or more.

Further, a basis weight of the surface material is appropriately selected. For example, it can be 350 g/m² or less and 300 g/m² or less. On the other hand, the lower limit of the basis weight is appropriately adjusted. For example, it is practical to be 100 g/m² or more.

Further, it is preferable that the surface material of the present disclosure does not have a thermoplastic resin layer exposed on the surface thereof. Examples of such a thermoplastic resin layer is a print layer containing a thermoplastic resin or a hot-melt resin layer containing a thermoplastic resin provided on a print. When the surface material in which the thermoplastic resin layer is exposed on the surface is subjected to thermoforming such as heat pressing using a mold, there is a possibility that the layer (a print layer containing a thermoplastic resin or a hot-melt resin layer containing a thermoplastic resin provided on a print) adheres to the mold and then the layer of the thermoplastic resin is peeled off from the surface material. When the thermoplastic resin layer is peeled off, the print is likely to fall off. As a result, it may be difficult to provide a surface material capable of realizing an automobile interior material having improved design properties.

Next, a method of manufacturing the surface material of the present disclosure will be described by way of example.

First, a black fabric such as a woven fabric, a knitted fabric or a nonwoven fabric is prepared. The method for producing the black fabric is not particularly limited.

When the black fabric is a woven fabric or a knitted fabric, it can be produced by weaving or knitting fibers (dyed fibers) in which black pigments are kneaded. In particular, it is preferable to adopt as a black fabric a fabric having dyed fibers as the constituent fiber. By being a surface material including such a black fabric, it is possible to provide a surface material capable of realizing an automotive interior material having a calm impression and improved design properties. In addition, it is possible to provide a surface material capable of realizing an automobile interior material that has high practicality and is difficult to cause color migration.

In the case where the black fabric is a nonwoven fabric, the black fabric can be produced by, for example, a dry method in which dyed fibers are entangled by a card device, an air-laying device, or the like, a wet method in which fibers are dispersed in a solvent to be entangled into a sheet form, a direct spinning method, or the like. In particular, it is preferable that the black fabric has a certain bulk so as to have excellent moldability when the surface material is molded. Therefore, it is preferable to adopt said dry method.

The black fabric formed as described above is preferably entangled by a water stream or a needle for ease of handling. In particular, it is preferable that the surface material is entangled by a needle so as not to impair the moldability at the time of molding. Some suitable needle entanglement conditions are not particularly limited. For example, it is preferred to entangle at a needle density of 300 to 1000 needles per cm², more preferably 300 to 600 needles per cm².

Further, if necessary, a solution or a dispersion of the binder resin is applied to the black fabric by a method such as foaming impregnation, coating or spraying, and then dried. Through this step, the constituent fibers of the black fabric may be bonded to each other by a binder resin. At this time, a black pigment may be contained in the binder to prepare a black fabric.

Finally, a solution or dispersion containing the print component capable of making up the print is partially applied onto one main surface of the black fabric. Thereby, the printing liquid is partially applied to at least one main surface of the black fabric. The method of applying the printing liquid is not particularly limited. For example, it is possible to adopt a method of preparing a cylinder having a through-hole on the entire surface, such as a cylindrical silk screen, and partially applying the printing liquid to one main surface of the black fabric through the through-hole of the cylinder. The solvent or dispersion medium is then removed from the black fabric partially coated with printing liquid. A method of removing the solvent or the dispersion medium is appropriately prepared, but for example, a method of heating and drying by a dryer can be adopted.

In this way, it is possible to produce a surface material which is partly provided with a print derived from the printing liquid on at least one main surface of the black fabric.

The surface material of the present disclosure may further include components such as a porous body, a film or a foam. Further, the surface material of the present disclosure may be subjected to a pressure treatment for smoothing the surface, such as a reliant press treatment. Further, it may be subjected to various secondary steps such as processing by punching the shape according to the application and usage mode.

### EXAMPLES

Hereinafter, the present invention will be specifically described by way of Examples, but these do not limit the scope of the present invention.

### Comparative Example 1

A fiber web was prepared by subjecting a dyed fiber (fineness: 2.2 dtex, fiber length: 51 mm, color: black) obtained by kneading a black pigment into polyethylene terephthalate to a carding machine. Then, the fiber web was provided to a cross layer machine and crossed with respect to the advancing direction of the fiber web to form a cross web. After that, the formed cross web was needle-punched from one side thereof. Then, the cross web having been subjected to the needle punching was passed through a pair of rolls consisting of a heated roll and a non-heated roll (slit: 0.5 mm) so as to be in contact with the roll set at 150° C. In this way, a needle punch web (color: black, basis weight: 180 g/m²) was formed.

Next, a foamed acrylic resin binder emulsion (solid content: 50% by mass, Tg: −40° C., cross-linking temperature of the acrylic resin binder: 160° C.) containing no pigment was applied from the opposite surface of the needle punched surface of the needle-punched web. Then, it was passed through the rolls whose gap distance was adjusted and dried in a can dryer at a temperature of 160° C.

In this way, a binder-bonded nonwoven fabric 1 (color: black, basis weight: 185 g/m², thickness: 1.6 mm, solid content mass of the acrylic-resin binder: g/m²) which is a black fabric was prepared.

In Comparative Example 1, the binder-bonded nonwoven fabric 1 prepared as described above was used as a surface material.

### Comparative Example 2

A printing liquid A of the following composition was prepared.
A black pigment emulsion: 0.1 parts by weight (solid content: 0.062 parts by mass)
An acrylic resin binder emulsion: 13.0 parts by weight (solid content: 6.5 parts by mass)
A silicone emulsion: 1.4 parts by weight (solid content: 0.5 parts by mass)
A thickener: 23.0 parts by weight (solid content: 0.61 parts by mass)
25% ammonia water: 1.0 parts by weight
Water: 61.5 parts by weight

Next, the binder-bonded nonwoven fabric 1 prepared in Comparative Example 1 was adopted as a black fabric. The printing liquid A was partially applied to the main surface of the binder-bonded nonwoven fabric 1 on which the acrylic resin binder emulsion was applied using a cylinder. Thereafter, the dispersion medium contained in the printing liquid was dried by a dryer at a temperature of 180° C. to be removed. In this way, a surface material (basis weight: 195 g/m², thickness: 1.5 mm, basis weight of black fabric: 185 g/m², and solid content mass of the print derived from the printing liquid: 10 g/m²) partially provided with a print on one main surface of the black fabric was produced.

### Example 1

A printing liquid B1 of the following composition was prepared.

A fluorine-based water and oil repellent: Asahi Guard AG-E300D . . . 20.0 parts by weight (solid content: 6.0 parts by mass)

A silicone emulsion: 0.4 parts by weight (solid content: 0.16 parts by mass)

A thickener: 20.0 parts by weight (solid content: 0.30 parts by mass)
25% ammonia water: 1.0 parts by weight
Water: 58.6 parts by weight

A printing liquid B1 was used instead of the printing liquid A. Except for this, in the same manner as in Comparative Example 2, a surface material (basis weight: 195 g/m², thickness: 1.5 mm, basis weight of black fabric: 185 g/m², solid content mass of the print derived from the printing liquid: 10 g/m²) partially provided with a print on one main surface of the black fabric was produced.

### Example 2

A printing liquid B2 of the following composition was prepared.

A fluorine-based water and oil repellent: Asahi Guard AG-E300D . . . 20.0 parts by weight (solid content: 6.0 parts by mass)

A blocked isocyanate-based compound: SU-268A 3.0 parts by weight (solid content: 0.9 parts by mass)

A silicone emulsion: 0.4 parts by weight (solid content: 0.16 parts by mass)

A thickener: 15.0 parts by weight (solid content: 0.23 parts by mass)
25% ammonia water: 1.0 parts by weight
Water: 60.6 parts by weight

A printing liquid B2 was used instead of the printing liquid A. Except for this, in the same manner as in Comparative Example 2, a surface material (basis weight: 195 g/m², thickness: 1.5 mm, basis weight of black fabric: 185 g/m², solid content mass of the print derived from the printing liquid: 10 g/m²) partially provided with a print on one main surface of the black fabric was produced.

In the surface material thus prepared, the blocked isocyanate-based compound was crosslinked with the fluorine-based water and oil repellent, so that the fluorine-based water and oil repellent contained in the print had a crosslinked moiety having a chemical structural formula of —NH—C(═O)—.

### Comparative Example 3

The binder-bonded nonwoven fabric 1 was subjected to a dilour machine. Further, a binder-bonded nonwoven fabric 2 (color: black, basis weight: 185 g/m², thickness: 1.6 mm, solid content mass of the acrylic-resin binder: 5 g/m²) that looked blacker than the binder-bonded nonwoven fabric 1 prepared in Comparative Example 1 was prepared.

In Comparative Example 3, the binder-bonded nonwoven fabric 2 thus prepared was used as a surface material.

### Comparative Example 4

A binder-bonded nonwoven fabric 2 was used as a black fabric instead of the binder-bonded nonwoven fabric 1. Except for this, in the same manner as in Comparative Example 2, a surface material (basis weight: 195 g/m², thickness: 1.5 mm, basis weight of black fabric: 185 g/m², solid content mass of the print derived from the printing liquid: 10 g/m²) partially provided with a print on one main surface of the black fabric was produced.

### Example 3

A binder-bonded nonwoven fabric 2 was used as a black fabric instead of the binder-bonded nonwoven fabric 1. Except for this, in the same manner as in Example 1, a surface material (basis weight: 195 g/m², thickness: 1.5 mm, basis weight of black fabric: 185 g/m², solid content mass of the print derived from the printing liquid: 10 g/m²) partially provided with a print on one main surface of the black fabric was produced.

### Example 4

A binder-bonded nonwoven fabric 2 was used as a black fabric instead of the binder-bonded nonwoven fabric 1. Except for this, in the same manner as in Example 2, a surface material (basis weight: 195 g/m², thickness: 1.5 mm, basis weight of black fabric: 185 g/m², solid content mass of the print derived from the printing liquid: 10 g/m²) partially provided with a print on one main surface of the black fabric was produced.

In the surface material thus prepared, the blocked isocyanate-based compound was crosslinked with the fluorine-based water and oil repellent, so that the fluorine-based water and oil repellent contained in the print had a crosslinked moiety having a chemical structural formula of —NH—C(═O)—.

### Example 5

A printing liquid B3 of the following composition was prepared.

A white pigment: 0.1 parts by weight (solid content: 0.062 parts by mass)

A thickener: 23.0 parts by weight (solid content: 0.61 parts by mass)

An acrylic resin binder emulsion: 13.0 parts by weight (solid content: 6.5 parts by mass)

A silicone emulsion: 1.4 parts by weight (solid content: 0.5 parts by mass)
25% ammonia water: 1.0 parts by weight
Water: 61.5 parts by weight

A printing liquid B3 was partially applied onto the print so as to overlap with a part of the print provided on the surface material prepared in the Example 1. Thereafter, the dispersion medium contained in the printing liquid B3 was dried by a dryer at a temperature of 180° C. to be removed. In this way, a surface material (basis weight: 199 g/m², thickness: 1.5 mm, basis weight of black fabric 185 g/m², solid content mass of the print derived from the printing liquid B1: 10 g/m², solid content mass of the print derived from the printing liquid B3: 4 g/m²) having a white print derived from the printing liquid B3 was produced in a portion on the print derived from the printing liquid B1.

On the main surface of the surface material thus prepared, there were a portion where the print derived from the printing liquid B1 was exposed and a portion where the white print derived from the printing liquid B3 was exposed.

### Example 6

A binder-bonded nonwoven fabric 3 (color: black, basis weight: 185 g/m², thickness: 1.6 mm, solid content mass of acrylic-resin binder: 12 g/m²) as a black fabric was prepared in the same manner as in Comparative Example 1, except that a needle punch web (color: black) having a basis weight adjusted to 173 g/m² was used.

A printing liquid B4 of the following composition was then prepared.

A silicone-based water repellent: NB-8800 . . . 15.0 parts by weight (solid content: 4.5 parts by mass)

An isocyanate-based compound: NY-99 . . . 2.0 parts by weight (solid content: 0.4 parts by mass)

A silicone emulsion: 0.4 parts by weight (solid content: 0.16 parts by mass)

A thickener: 25.0 parts by weight (solid content: 0.64 parts by mass)
25% ammonia water: 1.0 parts by weight
Water: 60.6 parts by weight

The printing liquid B4 was used instead of printing liquid A. Except for this, in the same manner as in Comparative Example 2, a surface material (basis weight: 195 g/m², thickness: 1.5 mm, basis weight of black fabric: 185 g/m², solid content mass of the print derived from the printing liquid: 10 g/m²) partially provided with a print on one main surface of the black fabric was produced.

In the surface material thus prepared, the isocyanate-based compound was crosslinked with the silicone-based water repellent, so that the silicone-based water repellent contained in the print had a crosslinked moiety having a chemical structural formula of —NH—C(═O)—.

### Example 7

The printing liquid B3 was partially applied onto the print so as to overlap with a portion of the print provided to the surface material prepared in Example 6. Thereafter, the dispersion medium contained in the printing liquid B3 was dried by a dryer at a temperature of 180° C. to be removed. In this way, a surface material (basis weight: 199 g/m², thickness: 1.5 mm, basis weight of black fabric 185 g/m², solid content mass of the print derived from the printing liquid B1: 10 g/m², solid content mass of the print derived from the printing liquid B3: 4 g/m²) having a white print derived from the printing liquid B3 was produced in a portion on the print derived from the printing liquid B4.

On the main surface of the surface material thus prepared, there were a portion where the print derived from the printing liquid B4 was exposed and a portion where the white print derived from the printing liquid B3 was exposed.

In any of the surface materials prepared as described above, each print was exposed on the surface material.

The physical properties of the surface materials prepared as described above are summarized in Table 2. Items not applicable are marked with “-” in the table. Further, the surface material which was evaluated to be the staining class 4-5th grade or the staining class 5th grade in the “evaluation method for color fastness” is marked with “o” in the table. On the other hand, the surface material which was evaluated to be the staining class 4th grade or a lower grade in the “evaluation method for color fastness” is marked with “x” in the table.

In addition, the surface of the surface material provided with the print including no black pigment was visually observed with the naked eye after subjecting the surface material to the “evaluation method for color fastness”. As a result, the surface material of which portion rubbed with the white cotton cloth looked lighter in color is marked with “*1” together with “o” in the table. In addition, the surface material of which portion rubbed with the white cotton cloth did not look as light as the surface material evaluated as “1” is marked with “*2” together with “o” in the table. This means a surface material rated as “0*2” is a surface material whose print is less likely to fall off from the surface material than a surface material rated as “0*1”.

### (Method for Evaluating Design Properties)

A human visually inspected the main surface of the prepared surface material on which the print was partially provided (in Comparative Examples 1 and 3, the main surface of the binder-bonded nonwoven fabric 1 or 2 on which the acrylic resin binder emulsion was applied). Then, the design properties were evaluated.

Surface material which had a pattern in which the print was darker (specifically, blacker) than the black fabric so as to be evaluated to be rich in design properties was marked with “o” in the table. On the other hand, a surface material that was evaluated as inferior in design properties because the surface material did not have a pattern, and a surface material that was evaluated as inferior in design properties because the surface material had a pattern in which the print was lighter than the black fabric, were marked with “x” in the table.

In the surface material prepared in Example 5, the average brightness (Lp) of the print was calculated by measuring the brightness of the print derived from the printing liquid B1 exposed on the main surface.

In addition, in the surface material prepared in Example 7, the average brightness (Lp) of the print was calculated by measuring the brightness of the print derived from the printing liquid B4 exposed on the main surface.

TABLE 2

| | | Average | | | | |
|---|---|---|---|---|---|---|
| | | brightness | | | | |
| | | on the | | | | |
| | | main | | | | |
| | Presence or | surface | | | Evaluation | |
| | absence of | of the | Average | | results of | |
| | black | black | brightness | Brightness | fastness | Evaluation |
| | pigment | fabric. | on the print | difference | against | results |
| | in print | (Lb) | (Lp) | (ΔL) | friction | in design |
| Comparative | — | 17.4 | — | — | ○ | x |
| Example 1 | | | | | | |
| Comparative | presence | 17.4 | 23.1 | 5.7 | x | x |
| Example 2 | | | | | | |
| Example 1 | absence | 17.4 | 14.5 | −2.9 | ○※1 | ○ |
| Exemple 2 | absence | 17.4 | 15.1 | −2.3 | ○※2 | ○ |
| Comparative | — | 11.0 | — | — | ○ | x |
| Example 3 | | | | | | |
| Comparative | presence | 11.0 | 14.5 | 3.5 | x | x |
| Example 4 | | | | | | |
| Example 3 | absence | 11.0 | 7.3 | −3.7 | ○※1 | ○ |
| Example 4 | absence | 11.0 | 8.2 | −2.8 | ○※2 | ○ |
| Example 5 | absence | 17.4 | 14.5 | −2.9 | ○※1 | ○ |
| Example 6 | absence | 18.5 | 17.6 | −0.9 | ○※2 | ○ |
| Example 7 | absence | 18.5 | 18.4 | −0.1 | ○※2 | ○ |

### INDUSTRIAL APPLICABILITY

The surface material of the present disclosure can be used as a surface material of various interior materials, in particular, a surface material of an interior material for a vehicle such as a ceiling, a door side, a pillar garnish and a rear package of a vehicle.

1. A surface material, comprising: a print provided on a part of a main surface of a black fabric, wherein
a brightness difference (ΔL, ΔL=Lp−Lb) between an average brightness on the main surface of the black fabric (Lb) and an average brightness on the print provided on the main surface (Lp) is less than 0.

2. The surface material according to claim 1, wherein the print contains a fluorine-based water and oil repellent.

3. The surface material according to claim 2, wherein the fluorine-based water and oil repellent has a crosslinked moiety having a chemical structural formula of
—NH—C(═O)—.

4. The surface material according to claim 1, wherein the print contains a silicone-based water repellent having a crosslinked moiety having a chemical structural formula of —NH—C(═O)—.

5. The surface material according to claim 1, wherein
the surface material has been evaluated as 4-5th grade or 5th grade as a result of a judgment for staining on a surface of a white cotton cloth rubbed against the main surface of the surface material after being subjected to “a) dry test” in “9.2 Rubbing Tester II Method” in “Test methods for color fastness to rubbing (JIS L0849: 2013)”, and
the judgement is carried out in accordance with “Table 3—Judgment criteria for staining” in “3) Judgment of Staining” in “General principles of testing methods for color fastness (JIS L0801: 2011)”.
